(19) United States
(12) Patent Application Publication
(10) Pub. No.: US 2024/0396278 A1
(43) Pub. Date: Nov. 28, 2024

(54) PNEUMATIC CRIMPING TOOL

(71) Applicant: ZOLLER & FRÖHLICH GMBH, Wangen im Allgäu (DE)

(72) Inventors: Florian STRUPP, Gräfelfing (DE); Christoph Fröhlich, Wangen (DE); Steffen HARTINGER, Wangen (DE)

(73) Assignee: ZOLLER & FRÖHLICH GMBH, Wangen im Allgäu (DE)

(21) Appl. No.: 18/689,377

(22) PCT Filed: Sep. 6, 2022
(86) PCT No.: PCT/EP2022/074766

§ 371 Date: Mar. 5, 2024

(30) Foreign Application Priority Data
Sep. 7, 2021 (DE) 10 2021 123 085.3

(51) Int. Cl. H01R 43/048; H01R 43/055

(52) U.S. Cl. CPC H01R 43/0488; H01R 43/055

(57) ABSTRACT

A pneumatic crimping tool has a crimping axis, along which a contact and a cable end can be introduced into a crimping opening, wherein a plurality of punches can be introduced into the crimping opening radially to the crimping axis. An adjusting wheel is provided, which surrounds the crimping axis, the radial crimping depth being adjustable by rotating the adjusting wheel.

### CROSS REFERENCE TO RELATED APPLICATIONS

This application is a National Phase Application of and claims priority to International Application Number PCT/EP2022/074766, filed Sep. 6, 2022, which claims priority to German Application Number 102021123085.3, filed Sep. 7, 2021, the entire disclosures of each of which are incorporated herein by reference.

### BACKGROUND

The disclosure relates to a pneumatic crimping device or respectively a pneumatic crimping tool according to the independent claim.

Crimping devices or crimpers are used to attach a contact element, hereinafter referred to as contact, to a stripped electrical cable end to establish a mechanical and electrical connection. For this purpose, the stripped cable end or the wire strand is inserted into the opening of a socket-like portion of the contact along a so-called crimping axis, whereupon the socket-like portion is pressed together radially to form a crimping axis and is thereby reshaped. This reduces the size of the opening and clamps the wire strand.

In this document, the term ‘socket-like portion’ also refers to a socket-like portion that is circumferentially not fully closed, e.g., with a longitudinal slot. This may be reduced or even completely closed during the crimping process.

Crimpers are known that are operated completely manually. Printed publication DE 100 60 165 A1, for example, shows manual crimping pliers with four punches that are moved radially to the crimping axis inward toward the contact. An adjusting wheel is shown which can be used to adjust the crimping depth, i.e., the radial path of the punches. The axis of rotation of the adjusting wheel is arranged tangentially to the crimping axis.

Pneumatic crimping tools are known from the state of the art, which are also configured as hand-held devices, i.e., they are held in one hand while the cable ends to be crimped with the contact loosely attached to them are fed individually with the other hand.

In this document, the term ‘pneumatic crimping tool’ refers to a semi-automatic crimping device whose energy supply for forming the socket-like portion of the contact is provided solely via at least one terminal for a pressurized fluid, usually inexpensive compressed air. Such pneumatic crimping tools do not have an electric drive.

Furthermore, device-technologically more complex pneumatic crimping tools with feet or frames are known, which can be placed on a table or workbench so that the operator has both hands free during the crimping process. Such pneumatic crimping tools are shown, for example, on the Internet at https://www.dmctools.com/oscar/catalogue/wa23_3606/ and at https://www.rennsteig.us/products/crimping-tools/multi-indent-pneumatic-crimping-tools and at https://www.buydeutsch.com/collections/crimpers/products/hdp-400.

A disadvantage of the above-mentioned pneumatic crimping tools of the prior art is the difficult adjustment or lack of adjustment of the crimping depth, i.e., the radial feed movement of the punch.

### SUMMARY

In view of this, the object of the disclosure is to create a pneumatic crimping tool in which the adjustment of the crimping depth is facilitated.

This object is solved by a pneumatic crimping tool with the features of the independent claim.

Further advantageous examples of the disclosure are described in the dependent patent claims.

The claimed pneumatic crimping tool has a crimping opening through which a crimping axis extends, along which a contact and a stripped cable end are inserted into the crimping opening. The crimping process then takes place, in which at least two punches for crimping, preferably four, are moved into the crimping opening with a crimping force applied radially to the crimping axis. According to the disclosure, an adjusting wheel that surrounds the crimping axis is provided, wherein the crimping depth is adjustable by rotating the adjusting wheel.

The pneumatic crimping tool according to the disclosure is device-technically simple and visually appealing if the adjusting wheel concentrically surrounds the crimping axis, wherein the crimping depth is adjustable by rotating the adjusting wheel around the crimping axis.

If the adjusting wheel has a rotating scale on the front side for indicating the crimping depth, this is particularly easy to read.

The pneumatic crimping tool according to the disclosure is device-technically simple and visually appealing if it has an at least sectionally cylindrical housing whose central axis is the crimping axis.

Preferably, the adjusting wheel is positionable along the crimping axis via an external thread and has a stop for limiting the crimping depth, which indirectly limits the radial path of the punches. The external thread engages in an internal thread of the at least sectionally cylindrical housing or of an outer ring fixed to the housing.

It is particularly preferred if knurled screws—e.g., three—are arranged on the circumference of the adjusting wheel to fix the adjusting wheel after it has been positioned.

An additional stationary scale for indicating the crimping depth may be attached to an outer circumference of the outer ring.

Preferably, a locking sheet is attached to the outer ring or housing to secure the adjusting wheel. This prevents the adjusting wheel from falling out by unscrewing it completely.

In a particularly preferred further development, a ring-shaped crimping cone is provided, which is movable pneumatically along the crimping axis up to the stop formed on the adjusting wheel during the crimping process. The punches are moved into the crimping opening radially to the crimping axis via a conical inner circumference of the crimping cone, which preferably has flat, acute-angled running surfaces for the rollers of the crimping punches. The less steep the inner circumference of the crimping cone, the higher the crimping force of the punches for a given force on the crimping cone.

In one variant of the disclosure, the crimping cone is butted along an inner circumferential surface, wherein rollers preferably formed on the punches are guided on preferably flat running surfaces angled in accordance with the cone angle, so that friction-optimized guiding and adjustment is ensured.

In terms of device technology, it is simple if the crimping cone is guided in the outer ring or in the at least sectionally cylindrical housing.

Preferably, the pneumatic crimping tool according to the disclosure has a double-acting pneumatic cylinder. If this is a differential cylinder, its piston crown chamber can act in the closing direction and its annular chamber in the opening direction of the punches-preferably on the crimping cone.

For axial and angular offset of the pneumatic cylinder and crimping cone, a piston of the pneumatic cylinder is preferably connected to the crimping cone via a compensating element.

When the adjusting wheel is screwed into the outer ring, this is preferably attached directly or indirectly to the pneumatic cylinder via at least two-preferably three-tension rods. This supports the adjusting wheel when the crimping cone reaches the stop of the adjusting wheel during the crimping process.

It is particularly preferred when the pneumatic crimping tool according to the disclosure has an exchangeable contact stop. This allows the crimping position to be adjusted.

Preferably, the contact stop is tensioned against the insertion direction by a spring along the crimping axis to compensate for linear expansion of the contact during the crimping process.

Access to the punches can be prevented with a spring-tensioned protective flap if no contact stop is installed.

It is particularly preferable if the punches are interchangeable, or if a punch guide is interchangeable with the punches. This allows the crimping shape to be adapted.

In an optional embodiment, two retaining jaws are provided which are arranged at least sectionally inside the adjusting wheel and which are clamped radially in the direction of the crimping axis and thus inward toward each other via at least one magnet. This allows the contact and the wire strand to be centered in relation to each other.

Preferably, the retaining jaws have a projection or shoulder, e.g., a handle edge, directed against the insertion direction to be able to be opened again against the force of at least one magnet.

Preferably, the retaining jaws are guided radially via a respective guiding pivot. The guiding pivots may be configured in such a way that the retaining jaws are guided radially, axially and/or via the outer contour also in the circumferential direction of the guiding pivots. In the optional configuration of the retaining jaws, the guiding pivots are detachably fastened—e.g., via a respective holder and a respective screw.

In another optional embodiment, a contact magazine is provided which is arranged at least sectionally inside the adjusting wheel and which has passage recesses aligned parallel to the crimping axis for receiving a respective contact. This can improve handling and may increase the productivity of the pneumatic crimping tool according to the disclosure.

Preferably, the passage recesses are arranged in a rectilinear row extending perpendicular to the crimping axis, wherein the contact magazine is manually movable along the row. This can further improve handling and may increase the productivity of the pneumatic crimping tool according to the disclosure.

The contact magazine can be moved particularly quickly and precisely between the individual crimping processes if a stepped latching device is provided corresponding to a distance from the passage recesses. This may be formed by a ball pressure screw and a corresponding contour on the contact magazine.

In a preferred embodiment of the pneumatic crimping tool according to the disclosure, the two options mentioned, i.e., the retaining jaws and the contact magazine, may be mounted alternatively to each other.

It is particularly preferred due to device technological and visual reasons if the adjusting wheel with its scale and the outer ring and the housing are concentric to the crimping opening and the crimping axis. Furthermore, the punch guide and the pneumatic cylinder and the crimping cone and the compensating element may also be concentric to the crimping opening and the crimping axis.

It is particularly preferred due to device technological and visual reasons if the knurled screws are evenly distributed around the circumference of the adjusting wheel.

It is particularly preferred due to device technological reasons if the tension rods are evenly distributed at the circumference of the adjusting wheel and the pneumatic cylinder.

The claimed pneumatic crimping tool is configured as a tabletop device and therefore preferably has a foot. The inclination of the crimping axis relative to the foot is adjustable via an adjusting device. The adjusting device is preferably an adjustment screw, via which a distance between a lower housing portion and the foot can be changed.

### BRIEF DESCRIPTION OF THE DRAWINGS

A configuration example of the pneumatic crimping tool according to the disclosure is shown in the Figures.

The following is shown:

FIG. 1 shows a section in a frontal view of a configuration example of the pneumatic crimping tool according to the disclosure,

FIG. 2 shows a side view of the pneumatic crimping tool from FIG. 1,

FIG. 3: shows a lateral view of the pneumatic crimping tool from FIG. 1 without housing,

FIG. 4 shows a longitudinal section of the pneumatic crimping tool from FIG. 1,

FIG. 5a shows frontal view of the pneumatic crimping tool with a first option,

FIG. 5b shows a section of the pneumatic crimping tool with the first option according to FIG. 5a in a perspective view and

FIG. 6 shows a section of the pneumatic crimping tool with a second option in a perspective view.

### DESCRIPTION

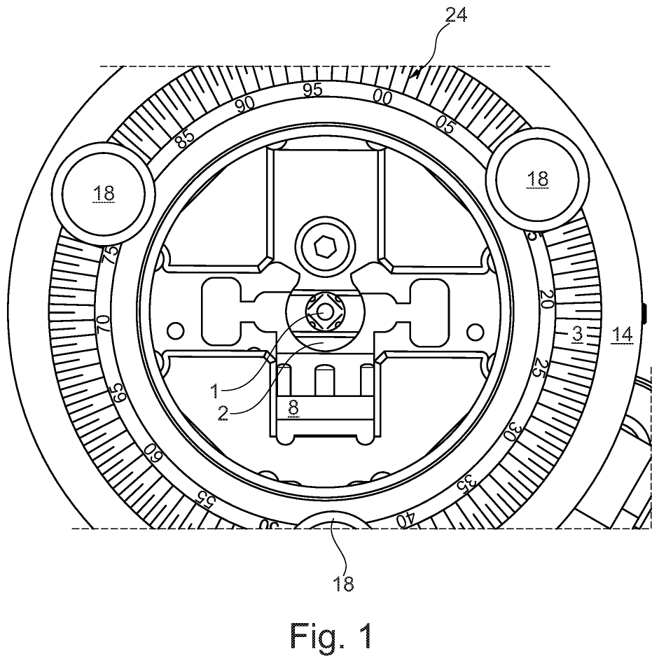

FIG. 1 shows a section of the configuration example of the pneumatic crimping tool according to the disclosure in a front view. The pneumatic crimping tool crimps loose, turned contacts (cross-section 0.08 mm² to 2.5 mm²) according to crimping form ‘4 indent’ and ‘4/8 indent’ on previously stripped cable ends. (The contacts and the cable ends are not shown).

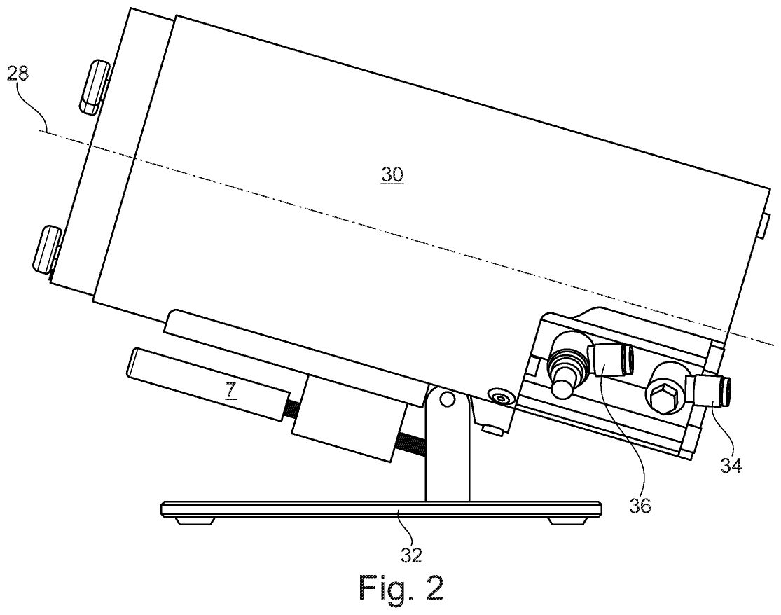

The contacts are fed individually to a crimping opening 1 along a so-called crimping axis (e.g., shown in FIG. 2), which is oriented perpendicular to the drawing plane in FIG. 1. The contacts are centered in the radial and longitudinal direction by a replaceable contact stop 2. More precisely, the individual contacts are centered radially, and the contact stop 2 forms a stop for the contact in the inserting direction into the drawing plane. The stripped cable end is pushed into the opening of a socket-like portion of the contact, and then the crimping process is triggered by a pneumatic switch (in this version a foot switch, not shown). After the crimping process, the crimped cable end is removed.

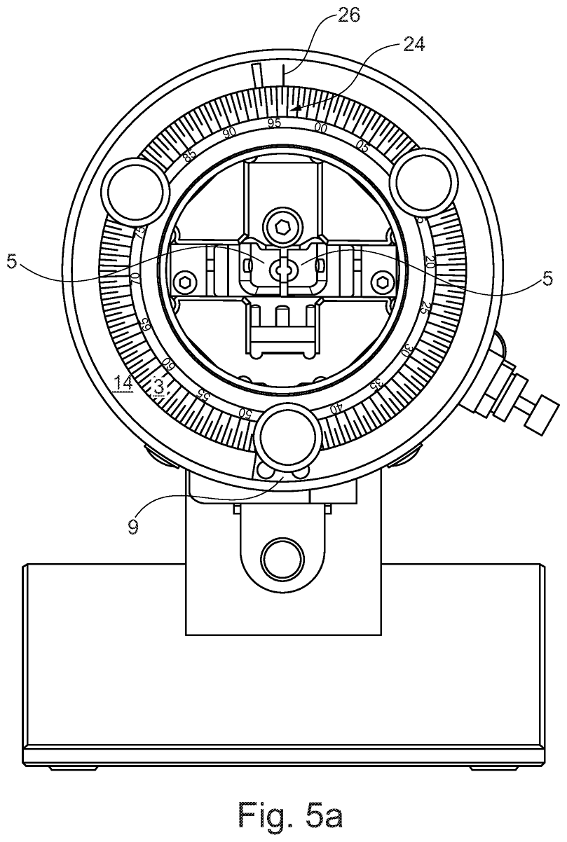

The (radial) crimping depth can be manually adjusted to 0.001 mm using an adjusting wheel 3 concentric to the crimping opening 1. The adjusting wheel 3 is guided in an outer ring 14 fixed to the housing via a thread and is positioned or adjusted perpendicular to the drawing plane. After adjustment, the adjusting wheel is tightened with three knurled screws 18. In order to adjust the crimping depth, the adjusting wheel 3 has a scale 24 labeled 0-100 (angle of rotation) in the circumferential direction. (A corresponding reading marker 26 attached to the outer ring 14 is shown in FIG. 5a).

A replaceable contact stop 2 is provided for each contact geometry, the inner diameter and length of which centers the contact in the radial and axial directions.

A spring-tensioned protective flap 8 prevents access to radial punches that can be moved into the crimping opening if no contact stop 2 is installed.

FIG. 2 shows a side view of the complete pneumatic crimping tool from FIG. 1. The height of the pneumatic crimping tool and the inclination of its crimping axis 28 is adjustable via an adjustment screw 7 via a hinge. The adjustment screw 7 couples a circular cylindrical housing 30, which is concentric to the crimping axis 28, to a foot 32 of the pneumatic crimping tool.

Furthermore, a pneumatic connection 34 acting in the closing direction and a pneumatic connection 36 acting in the opening direction are arranged in a recess of the housing 30.

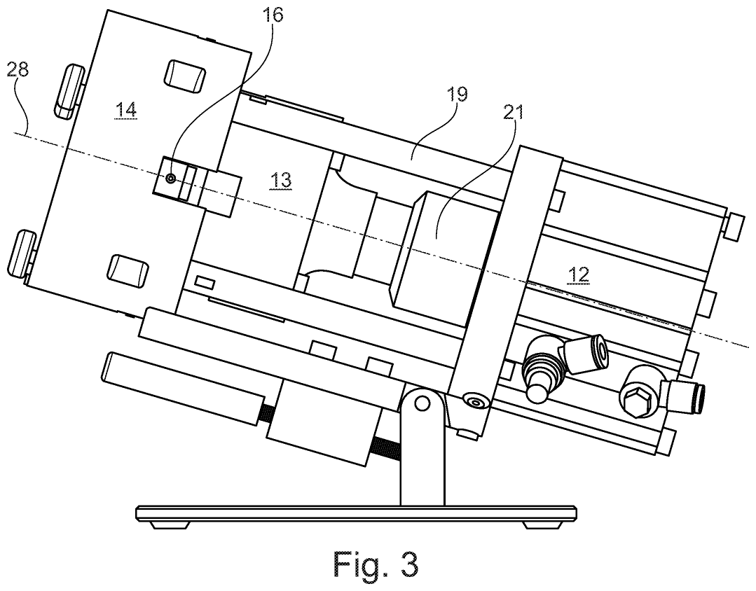

FIG. 3 shows the pneumatic crimping tool from FIG. 2 in a side view without housing 30. It can be seen that the two pneumatic connections 34, 36 are arranged on a pneumatic cylinder 12. The pneumatic cylinder 12 is coupled to a crimping cone 13 via a compensating element 21 for axial and angular offset of the pneumatic cylinder 12, wherein the crimping cone 13 can be moved along the crimping axis 28 relative to the outer ring 14 fixed to the housing.

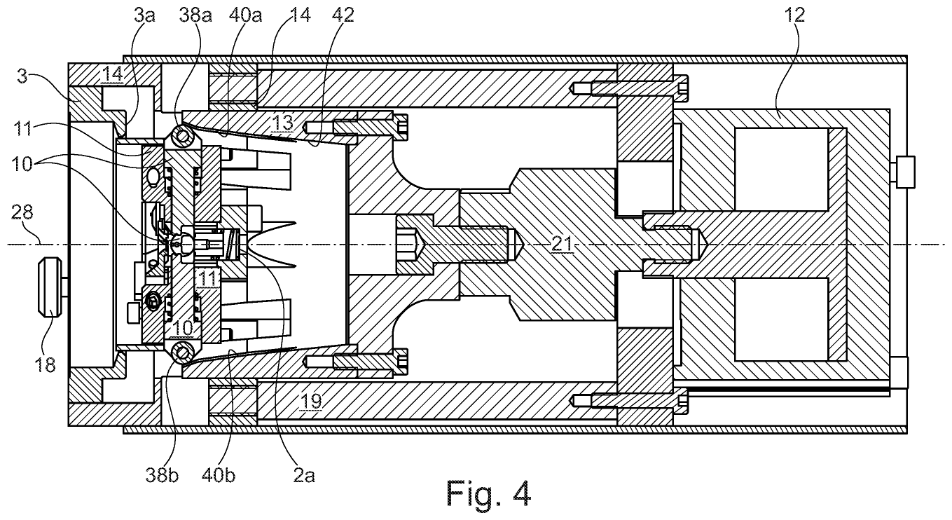

In order to optimize the crimp quality, a punch guide (shown in FIG. 4) is positionable via threaded pins 16, of which only one is shown in FIG. 1 and in FIG. 5b described below.

FIG. 4 shows the pneumatic crimping tool from FIG. 1 in a longitudinal section without the foot 32.

Four punches 10 are guided in the punch guide 11. When the crimping process is triggered by actuating the pneumatic switch, the piston of the pneumatic cylinder 12 pushes the crimping cone 13 forward (to the left in FIG. 2). The geometry of the crimping cone 13 results in an increase in the crimping force of the pneumatic cylinder 12 and a redirection of 90 degrees (from the axial direction to a radial direction inward). This happens with a conical inner circumference of the crimping cone 13. The punches 10 move together around the contact in the crimping opening 1. The crimping cone 13 is guided in the outer ring 14. Tension rods 19 absorb the crimping force of the pneumatic cylinder 12.

In the configuration example shown, rollers 38a, 38b, which roll along running surfaces 40a and 40b, respectively, are arranged at the top and bottom end portions of the punches 10 in FIG. 4. These running surfaces 40a, 40b are formed along the butted inner circumference 42 of the crimping cone 13 and are thus angled according to the cone angle.

When the pneumatic switch is released, the pneumatic cylinder 12 acts in the opposite direction and the punches 10 are opened by the respective radial springs.

The crimping depth is set by the adjusting wheel 3 by limiting the feed of the crimping cone 13 with a stop 3a on the adjusting wheel 3.

It is possible to change the punches 10 to adjust the crimping form.

The contact stop 2 centers the contact in the radial and longitudinal direction. It is pretensioned by a spring 2a to compensate for the linear expansion of the contact during the crimping process.

FIG. 5a shows the already explained scale 24 of the rotatable adjusting wheel 3 with the reading marker 26 of the stationary outer ring 14. A locking sheet 9 is furthermore shown, which prevents the adjusting wheel 3 from being completely unscrewed.

FIGS. 5a and 5b show optional retaining jaws 5 for improving the crimp quality, which center the contact and the wire strand of the cable end in relation to each other.

FIG. 5b shows that the retaining jaws 5 are closed by magnet 15 and are opened manually by handle edge 17. The retaining jaws 5 are guided by a respective stationary cylindrical pin 5a.

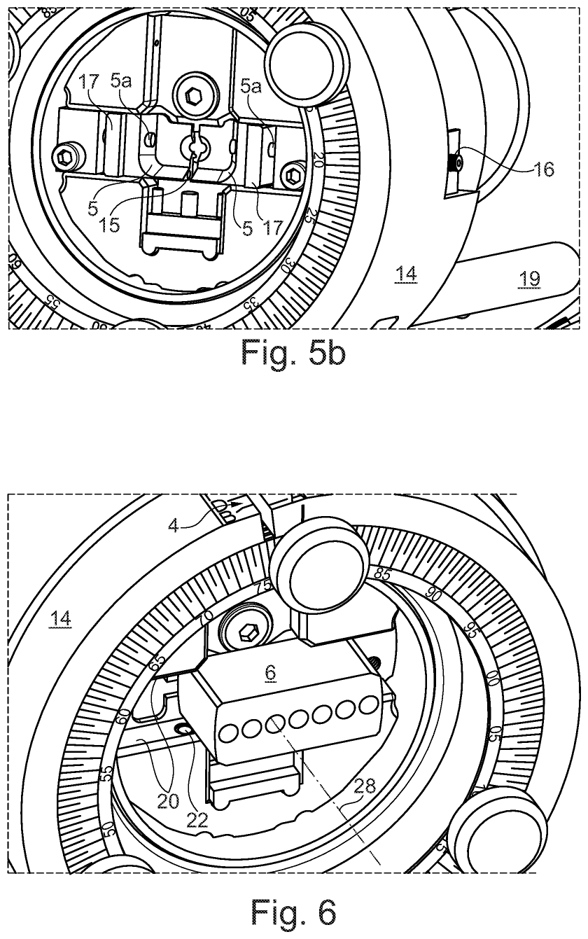

With reference to FIG. 6, a scale 4 is provided on the outer circumference of the outer ring 14 in the axial direction with 8 steps (letters A to H in the configuration examples shown) for the number of complete revolutions of the adjusting wheel 3. (Only the first three steps are shown in FIG. 6).

FIG. 6 shows an optional contact magazine 6 for improved handling. The contact magazine 6 holds several contacts in respective passage recesses and is moved laterally in steps once per crimping process. Each contact is pushed forward into the crimping opening 1 using the respective cable end. If the contact magazine 6 is empty, it is reloaded and moved in steps in the opposite direction. A groove-like guide 20 with two flanks is provided for the contact magazine 6 for this purpose.

The contact magazine 6 can be moved in steps via a ball pressure screw 22 in one of the flanks of the guide 20 and a corresponding contour on the contact magazine 6 for engaging.

The geometry of the passage recesses for the contacts is matched to the respective geometry of the contacts, which is why the contact magazine 6 is interchangeable.

The disclosed pneumatic crimping tool does not have electrical components. It has a crimping axis along which a contact and a cable end are insertable into a crimping opening, wherein several punches can be moved into the crimping opening radially to the crimping axis. An adjusting wheel is provided, which preferably concentrically surrounds the crimping axis, wherein the radial crimping depth is adjustable by rotating the adjusting wheel. Preferably, a stop is formed on the adjusting wheel for this purpose, which indirectly limits the retraction movement of the punches.

### LIST OF REFERENCE SYMBOLS

1 crimping opening
2 contact stop
2a spring
3 adjusting wheel
3a stop
4 stationary scale
5 retaining jaw
5a cylindrical pin
6 contact magazine
7 adjustment screw
8 protective flap
9 locking sheet
10 punch
11 punch guide
12 pneumatic cylinder
13 crimping cone
14 outer ring
15 magnet
16 threaded pin
17 handle edge
18 knurled screw
19 tension rod
20 guide
21 compensating element
22 ball pressure screw
24 rotating scale
26 reading marker
28 crimping axis
30 housing
32 foot
34 pneumatic connection
36 pneumatic connection
38 roller
40 running surface
42 inner circumference

What is claimed is:

1. A pneumatic crimping tool comprises a crimping opening through which a crimping axis extends, along which a contact and a cable end are insertable into the crimping opening, wherein at least two punches for crimping can be moved into the crimping opening with a crimping force applied radially to the crimping axis, further comprising an adjusting wheel that surrounds the crimping axis, wherein a crimping depth is adjustable by rotating the adjusting wheel.

2. The pneumatic crimping tool according to claim 1, wherein the adjusting wheel has a scale on a front side for indicating the crimping depth.

3. The pneumatic crimping tool according to claim 1, wherein the adjusting wheel is positionable along the crimping axis via an external thread and has a stop for limiting the crimping depth, wherein the external thread engages in an internal thread of an at least sectionally cylindrical housing or of an outer ring fixed to the at least sectionally cylindrical housing.

4. The pneumatic crimping tool according to claim 3, wherein an additional scale for indicating the crimping depth is attached to an outer circumference of the outer ring.

5. The pneumatic crimping tool according to claim 3, with a ring-shaped crimping cone which is movable along the crimping axis up to the stop, wherein the at least two punches for crimping can be moved into the crimping opening via a conical inner circumference of the ring-shaped crimping cone.

6. The pneumatic crimping tool according to claim 5, wherein the ring-shaped crimping cone has running surfaces for rollers of the at least two punches for crimping.

7. The pneumatic crimping tool according to claim 5, wherein the ring-shaped crimping cone is guided in the outer ring or in the at least sectionally cylindrical housing.

8. The pneumatic crimping tool according to claim 3, with a double-acting pneumatic cylinder.

9. The pneumatic crimping tool according to claim 8, wherein the outer ring is attached directly or indirectly to the double-acting pneumatic cylinder via at least two tension rods.

10. The pneumatic crimping tool according to claim 1, having an exchangeable contact stop.

11. The pneumatic crimping tool according to claim 10, having a spring-tensioned protective flap for covering a receptacle for the exchangeable contact stop.

12. The pneumatic crimping tool according to claim 1, wherein the at least two punches for crimping are interchangeable, or wherein a punch guide is interchangeable with the at least two punches for crimping.

13. The pneumatic crimping tool according to claim 1, having two retaining jaws which are arranged at least sectionally inside the adjusting wheel and which are clamped radially in a direction of the crimping axis via at least one magnet.

14. The pneumatic crimping tool according to claim 13, wherein the two retaining jaws are guided via a respective guiding pivot, preferably in a radial direction, an axial direction, and via an outer contour.

15. The pneumatic crimping tool according to claim 1, having a contact magazine which is arranged at least sectionally inside the adjusting wheel, the contact magazine having passage recesses aligned parallel to the crimping axis for receiving a respective contact.

16. The pneumatic crimping tool according to claim 15, wherein the passage recesses are arranged in a rectilinear row extending perpendicularly to the crimping axis, and wherein the contact magazine is manually movable along the rectilinear row in a guided manner.

17. The pneumatic crimping tool according to claim 6, wherein the running surfaces are flat and angled at an acute angle.
